(19) United States
(12) Patent Application Publication
(10) Pub. No.: US 2009/0116834 A1
(43) Pub. Date: May 7, 2009

(54) OPTICAL TRANSMISSION APPARATUS AND RESTART CONTROL METHOD

(75) Inventors: Katsumi Sugawa, Fukuoka (JP); Makoto Ohtou, Fukuoka (JP); Akira Yamamoto, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/234,904

(22) Filed: Sep. 22, 2008

(30) Foreign Application Priority Data
Nov. 2, 2007 (JP) 2007-286229

(51) Int. Cl. H04B 10/00

(52) U.S. Cl. 398/6

(57) ABSTRACT

An apparatus comprises an optical level controller for autonomously controlling an optical device such that an optical level of the supplied optical signal becomes an objective level, and a controlled variable storer for storing a controlled variable in storage if a restart is required, the optical level controller providing the controlled variable to control the optical signal, wherein the optical level controller starts the control of optical device after the restart while the controlled variable stored in the storage by the controlled variable storer is set at an initial value.

### CROSS-REFERENCE TO RELATED APPLICATIONS

This application is based upon and claims the benefit of priority of the prior Japanese Application No. 2007-286229, filed on Nov. 2, 2007, the entire contents of which are incorporated herein by reference.

### BACKGROUND

1. Field

The present invention relates to an optical transmission apparatus and a restart control method, particularly to an optical transmission apparatus and a restart control method which can prevent unstable communication even if restart is performed.

2. Description of the Related Art

Recently, larger capacity and longer distance has been demanded in a network with increasing communication capacity and communication distance. An optical network, in which Wavelength Division Multiplex (WDM) is utilized, is used to satisfy these demands in a core network.

An optical transmission apparatus called Optical Add and Drop Multiplexer (OADM) is used to establish connection with another network in and optical network in which Wavelength Division Multiplex (WDM) is utilized. In an OADM, any wavelength is added to any path and a signal light having any wavelength is dropped from the path and received from any path (for example, see Japanese Patent Application Laid-Open No. 2004-40437).

The optical add and drop multiplexer includes a mechanism in which autonomous control is performed to realize stable communication. In the mechanism, an optical level of the optical signal becomes a target level in each division-multiplexed wavelength (for example, see Japanese Patent Application Laid-Open No. 2005-208650.

### SUMMARY

In view of the foregoing, an object of the invention is to provide an optical transmission apparatus which can prevent unstable communication even if the restart is performed, and a restart control method.

According to an aspect of an embodiment, an apparatus comprises an optical level controller for autonomously controlling an optical device such that an optical level of the supplied optical signal becomes an objective level, and a controlled variable storer for storing a controlled variable in storage if a restart is required, the optical level controller providing the controlled variable to control the optical signal, wherein the optical level controller starts the control of the optical device after the restart while the controlled variable stored in the storage by the controlled variable storer is set at an initial value.

Additional objects and advantages of the embodiment will be set forth in part in the description which follows, and in part will be obvious from the description, or may be learned by practice of the invention.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The above-described embodiments of the present invention are intended as examples, and all embodiments of the present invention are not limited to including the features described above.

### BRIEF DESCRIPTION OF THE DRAWINGS

FIG. 1 shows an example of a configuration of a WDM communication system;

FIG. 2 shows a configuration of an optical add and drop multiplexer;

FIG. 3 shows a configuration of a main part of an optical add and drop multiplexing module;

FIG. 4 is a functional block diagram showing a function of an optical device control unit;

FIG. 5 is a flowchart showing an operation of the optical device control unit of FIG. 4;

FIG. 6 shows a modification of the optical add and drop multiplexing module; and

FIG. 7 is a flowchart showing an operation of a conventional optical device control unit.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

An optical transmission apparatus and a restart control method according to a preferred embodiment of the invention will be described in detail with reference to the accompanying drawings.

### Embodiment

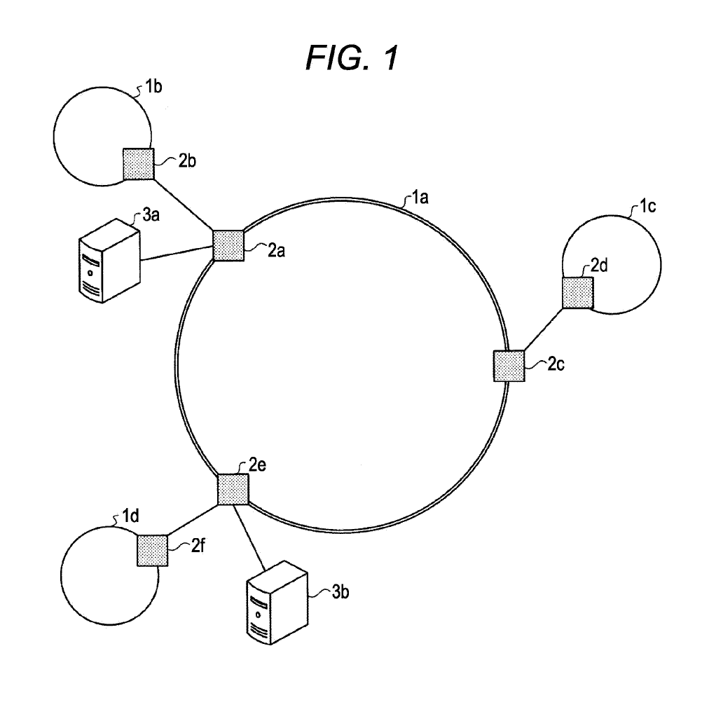

A WDM communication system including optical add and drop multiplexers 2a to 2f according to an embodiment of the invention will be described below. FIG. 1 shows an example of a configuration of the WDM communication system including the optical add and drop multiplexers 2a to 2f of the embodiment. In the configuration of the WDM communication system of FIG. 1, optical networks 1a to 1d are connected by the optical add and drop multiplexers 2a to 2f. Operation Systems (OPS) 3a and 3b are also connected to the WDM communication system in order to maintain and manage the optical add and drop multiplexers 2a to 2f.

Each of the optical add and drop multiplexers 2a to 2f includes a control mechanism in which autonomous control is performed such that an optical level of the optical signal becomes a target level in each division-multiplexed wavelength. The optical add and drop multiplexers 2a to 2f can maintain the stable communication state even if the control mechanism is restarted to update firmware or a programmable device in response to an instruction of each of the operation systems 3a and 3b.

In the example of FIG. 1, the optical add and drop multiplexers 2a to 2f are used to connect the optical networks to one another. The optical add and drop multiplexers 2a to 2f may be used to connect the optical network to other networks such as Ethernet (registered trademark) and an ATM (Asynchronous Transfer Mode) network.

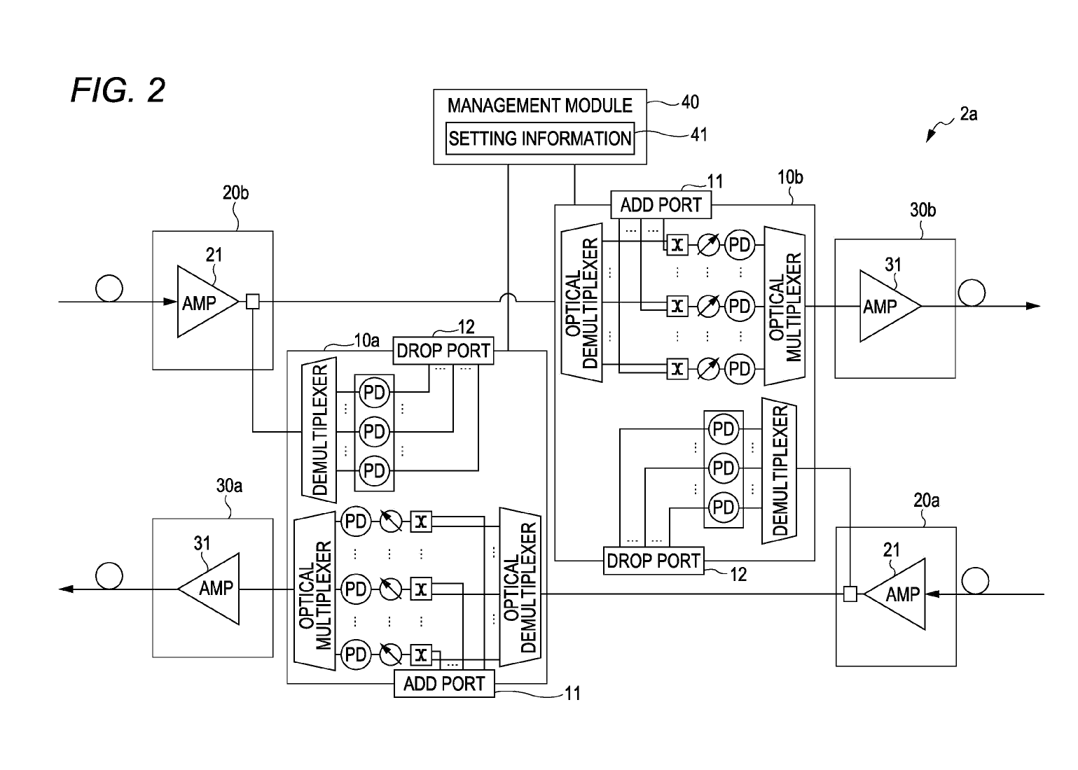

Configurations of the optical add and drop multiplexers 2a to 2f will be described. Because the optical add and drop multiplexers 2a to 2f have the similar configuration, the optical add and drop multiplexer 2a will be used as an example to describe the configuration. FIG. 2 shows a configuration of the optical add and drop multiplexer 2a. As shown in FIG. 2, the optical add and drop multiplexer 2a includes optical add and drop multiplexing modules 10a and 10b, reception amplifier modules 20a and 20b, transmission amplifier modules 30a and 30b, and a management module 40.

The optical add and drop multiplexing module 10a adds an optical signal fed from an add port 11 to an optical signal fed from the right direction of FIG. 2, and the optical add and drop multiplexing module 10a supplies the optical signal to the left direction of FIG. 2. The optical add and drop multiplexing module 10a drops a signal having a particular wavelength from an optical signal fed from the left direction of FIG. 2, and the optical add and drop multiplexing module 10a supplies the optical signal from a drop port 12. In the reception amplifier module 20a, the optical signal fed from the right direction of FIG. 2 is optical-amplified by an amplifier 21 and supplied to the optical add and drop multiplexing modules 10a and 10b. In the transmission amplifier module 30a, an amplifier 31 optical-amplifies a signal supplied to the left direction by the optical add and drop multiplexing module 10a.

The optical add and drop multiplexing module 10b adds the optical signal fed from the add port 11 to the optical signal fed from the left direction of FIG. 2, and the optical add and drop multiplexing module 10b supplies the optical signal to the right direction of FIG. 2. The optical add and drop multiplexing module 10b drops a signal having a particular wavelength from the optical signal fed from the right direction of FIG. 2, and the optical add and drop multiplexing module 10b supplies the optical signal from the drop port 12. In the reception amplifier module 20b, the optical signal fed from the left direction of FIG. 2 is optical-amplified by the amplifier 21 and supplied to the optical add and drop multiplexing modules 10a and 10b. In the transmission amplifier module 30b, the amplifier 31 optical-amplifies a signal supplied to the right direction by the optical add and drop multiplexing module 10a.

The management module 40 manages the optical add and drop multiplexing modules 10a and 10b based on setting information 41 stored therein. For example, the setting information 41 includes optical cross connect information indicating which an optical signal having a wavelength is added, which an optical signal having a wavelength is dropped, and which an optical signal having a wavelength is passed through. The management module 40 provides an instruction to the optical add and drop multiplexing modules 10a and 10b such that the optical device is set based on the optical cross connect information.

The setting information 41 is edited through the operation systems 3a and 3b (shown in FIG. 1) by a network manager, and setting information 41 is stored in a nonvolatile memory. Accordingly, the optical cross connect information set by the network manager is not lost even if the optical add and drop multiplexer 2a is restarted, and the optical cross connect information is used to reproduce the same state as the pre-restart after the restart.

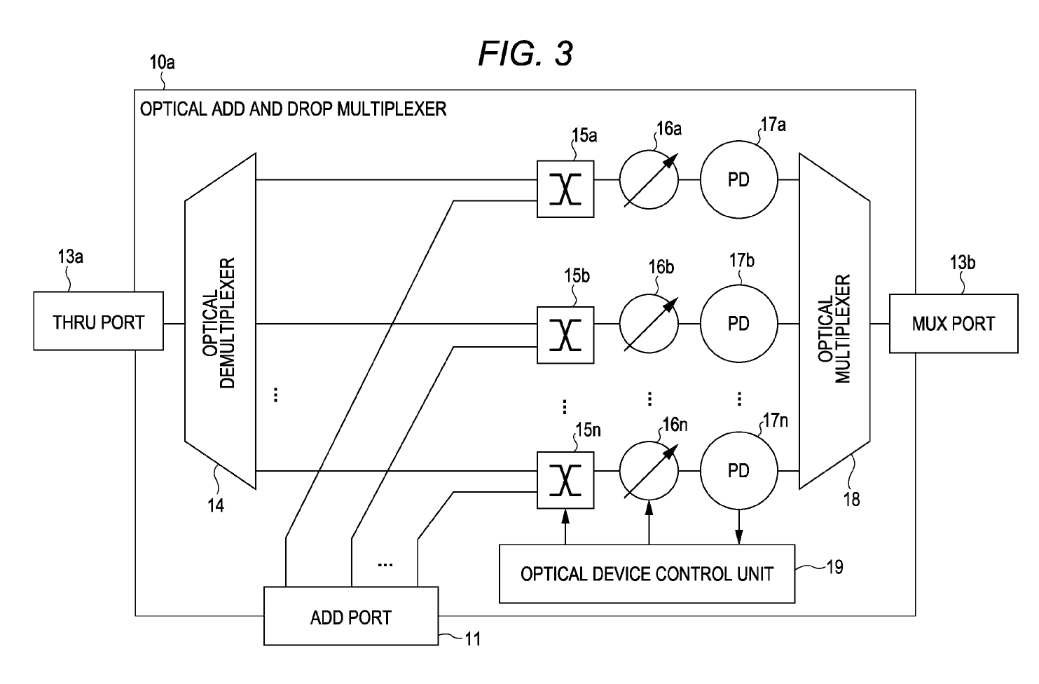

FIG. 3 shows a configuration of a main part of the optical add and drop multiplexing module 10a of FIG. 2. In FIG. 3, the configuration relating to the drop of the optical signal is omitted for the purpose of convenience. The optical add and drop multiplexing module 10b has a configuration similar to that of the optical add and drop multiplexing module 10a.

As shown in FIG. 3, in addition to the add port 11, the optical add and drop multiplexing module 10a includes a thru port 13a, a mux port 13b, an optical demultiplexer 14, optical switches 15a to 15n, Variable Optical Attenuators (VOAs) 16a to 16n, Photo Diodes (PDs) 17a to 17n, an optical multiplexer 18, and an optical device control unit 19.

The thru port 13a is used to receive the optical signal optical-amplified by the reception amplifier module 20a, and the optical demultiplexer 14 separates the optical signal received by the thru port 13a into each wavelength. The optical switches 15a to 15n are provided in each wavelength separated by the optical demultiplexer 14, and the optical switches 15a to 15n supplies one of the optical signal having the particular wavelength separated by the optical demultiplexer 14 and the optical signal having the particular wavelength received by the add port 11 to VOAs 16a to 16n, respectively.

VOAs 16a to 16n corresponding to the optical switches 15a to 15n are provided, respectively. VOAs 16a to 16n attenuate the optical signals such that optical levels of the optical signals supplied from the optical switches 15a to 15n become target optical levels, respectively. PDs 17a to 17n corresponding to VOAs 16a to 16n are provided, respectively. PDs 17a to 17n measure the optical levels of the optical signals supplied from VOAs 16a to 16n and supplies the measurement results to the optical device control unit 19, respectively.

The optical multiplexer 18 wavelength-multiplexes the optical signal having wavelengths supplied from VOAs 16a to 16n through PDs 17a to 17n. The mux port 13b is used to supply the division-multiplexed optical signal to the transmission amplifier module 30a from the optical multiplexer 18.

The optical device control unit 19 controls optical devices such as the optical switches 15a to 15n, VOAs 16a to 16n, and PDs 17a to 17n. Specifically, the optical device control unit 19 controls the optical switches 15a to 15n based on the optical cross connect information included in the setting information 41 such that the optical signal is correctly dropped. The optical device control unit 19 varies attenuations of VOAs 16a to 16n based on the measurement results of PDs 17a to 17n such that the optical levels of the optical signals having wavelengths become objective levels.

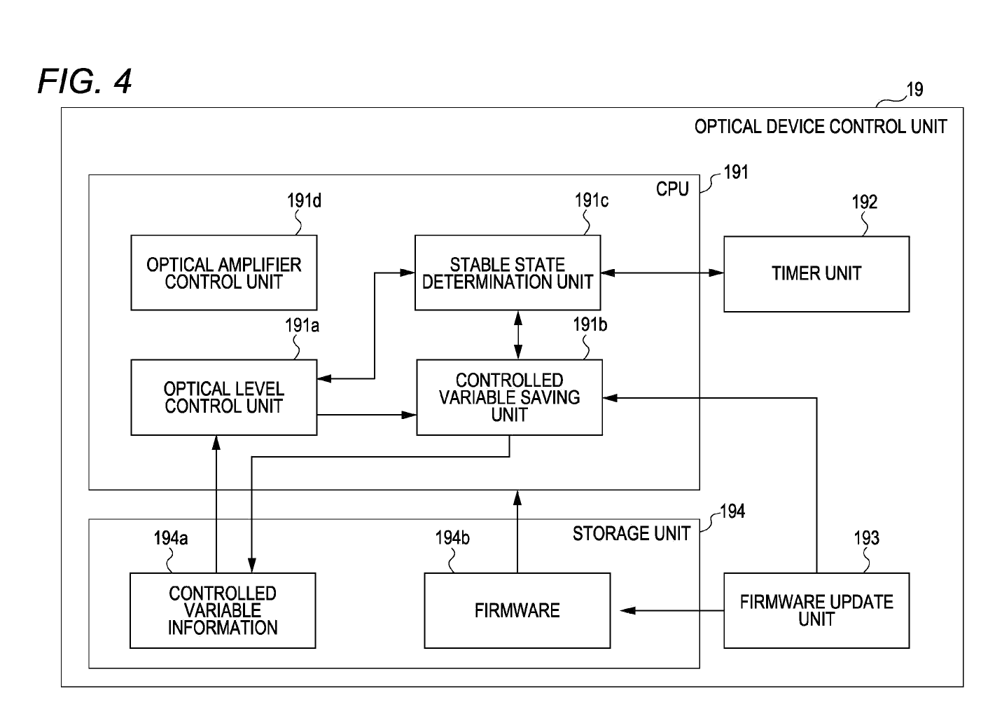

FIG. 4 is a detailed configuration of the optical device control unit 19. As shown in FIG. 4, the optical device control unit 19 includes a Central Processing Unit (CPU) 191, a timer unit 192, a firmware update unit 193, and a storage unit 194. In FIG. 4, the configuration relating to the control of the optical switch 15a to 15n is omitted for the purpose of convenience.

CPU 191 is an arithmetic processing device which can perform various pieces of arithmetic processing, and CPU 191 realizes various functions by executing firmware 194b stored in the storage unit 194. For example, CPU 191 executes the firmware 194b to realize an optical level control unit 191a, a controlled variable saving unit 191b, a stable state determination unit 191c, and an optical amplifier control unit 191d.

The optical level control unit 191a adjusts controlled variables of VOAs 16a to 16n based on the measurement results of PDs 17a to 17n such that the optical levels of the optical signals having wavelengths become the objective levels. The optical level control unit 191a varies the controlled variables of VOAs 16a to 16n little by little within a predetermined width such that a communication failure is not generated by rapidly changing the optical level.

The optical level control unit 191a uses information obtained from controlled variable information 194a stored in the storage unit 194 as initial values of the controlled variables given to VOAs 16a to 16n, when the control of VOAs 16a to 16n is resumed after the restart. As described later, the controlled variable saving unit 191b saves the controlled variables of VOAs 16a to 16n before the restart in the controlled variable information 194a. Therefore, the optical level control unit 191a can set the controlled variables of VOAs 16a to 16n at proper sizes for a short time after the restart to avoid the generation of the communication failure associated with the restart.

The controlled variable saving unit 191b stores the controlled variables applied to VOAs 16a to 16n by the optical level control unit 191a as controlled variable information 194a in the storage unit 194 before the restart is performed. The controlled variable saving unit 191b changes contents stored as the controlled variable information 194a according to the usage state of each wavelength.

The controlled variable saving unit 191b stores the controlled variable information 194a that the attenuation of VOA corresponding to the wavelength in non-operation should be maximized to set VOA corresponding to the wavelength in non-operation at a shut-down state in the storage unit 194 such that VOA corresponding to the wavelength in non-operation has an influence on other wavelengths in operation. Because the controlled variable saving unit 191b can start the control from the state in which the attenuation of VOA is maximized, the controlled variable saving unit 191b stores the controlled variable information 194a that the wavelength of ALD (Automatic Level Down) state, that is, the wavelength which is in operation while the signal is not fed, the controlled variable saving unit 191b should be set at the shut-down state in the storage unit 194.

The controlled variable saving unit 191b causes the stable state determination unit 191c to determine whether or not the wavelength is in operation while the signal is fed is stabilized. For the wavelength whose stability is determined by the stable state determination unit 191c, the controlled variable applied to the corresponding VOA is stored as the controlled variable information 194a which should be applied to VOA after the restart. On the other hand, for the wavelength whose instability is determined by the stable state determination unit 191c, because the proper controlled variable cannot specified after the restart, the stable state determination unit 191c stores the controlled variable information 194a that the wavelength should be set at the shut-down state in the storage unit 194.

In order to prevent the instability of the communication state during the restart, the optical level control unit 191a maximizes the attenuation of VOA to set the wavelength at the shut-down state before the restart is performed for VOA corresponding to the determination, made by the stable state determination unit 191c, that wavelength should be set at the shut-down state.

The stable state determination unit 191c monitors the measurement results of the optical levels transmitted from PDs 17a to 17n, and the stable state determination unit 191c determines whether or not each wavelength is stabilized. The determination whether or not each wavelength is stabilized is made based on whether or not a difference between the optical level and the target level of each wavelength falls within a predetermined range. The stable state determination unit 191c determines that the wavelength is not stabilized when the difference between the optical level and the target level of each wavelength does not fall within a predetermined range even after a predetermined time elapses.

The optical amplifier control unit 191d makes transitions of the reception amplifier modules 20a and 20b and the transmission amplifier modules 30a and 30b from an ALC (Automatic Level Control) mode in which the optical level of the division-multiplexed optical signal is kept constant to an AGC (Automatic Gain Control) mode in which a gain of the division-multiplexed optical signal is kept constant before the restart is performed.

In the case where the whole of the optical add and drop multiplexer 2a is not restarted but only the optical device control unit 19 is restarted, the communication continuously is conducted during the restart. However, when the reception amplifier module 20a is set in the ALC mode, in the case where the number of paths is increased or decreased to vary the number of wavelengths in the operation state during the restart, the gain control of each wavelength is not performed based on the proper number of wavelengths, which possibly causes a communication error. The transition to the AGC mode is made before the restart is performed, which allows the problem to be solved.

The timer unit 192 is timing means for measuring a time in which the stable state determination unit 191c waits for the stability of the wavelength. The firmware update unit 193 downloads an update-version file from another server to update the firmware 194b stored in the storage unit 194. The firmware update unit 193 also performs a process for restarting the optical device control unit 19 to execute the updated firmware 194b. The firmware update unit 193 provides an instruction to the controlled variable saving unit 191b to perform the saving processing of the controlled variable of VOAs 16a to 16n before the restart such that the communication does not become unstable after the restart.

The controlled variable information 194a and the firmware 194b are stored in the storage unit 194, and the storage unit 194 is formed by a nonvolatile memory such that the information is not lost after the restart.

In the configuration of FIG. 4, CPU 191 reads the firmware 194b to realize the control of VOAs 16a to 16n and the like. However, a part of or all the functions realized by CPU 191 may be realized with a programmable device such as FPGA (Field Programmable Gate Array) or a hard-wired logic device such as ASIC (Application Specific Integrated Circuit).

In the case where the function realized by CPU 191 is realized with the programmable device, preferably an update unit corresponding to the firmware update unit 193 is provided to enable logic update, and an instruction is provided to the controlled variable saving unit 191b to perform the saving processing of the controlled variable of VOAs 16a to 16n before the restart such that the communication does not become unstable during the restart associated with the logic update.

An operation of the optical device control unit 19 of FIG. 4 will be described in comparison with an operation of a conventional optical device control unit.

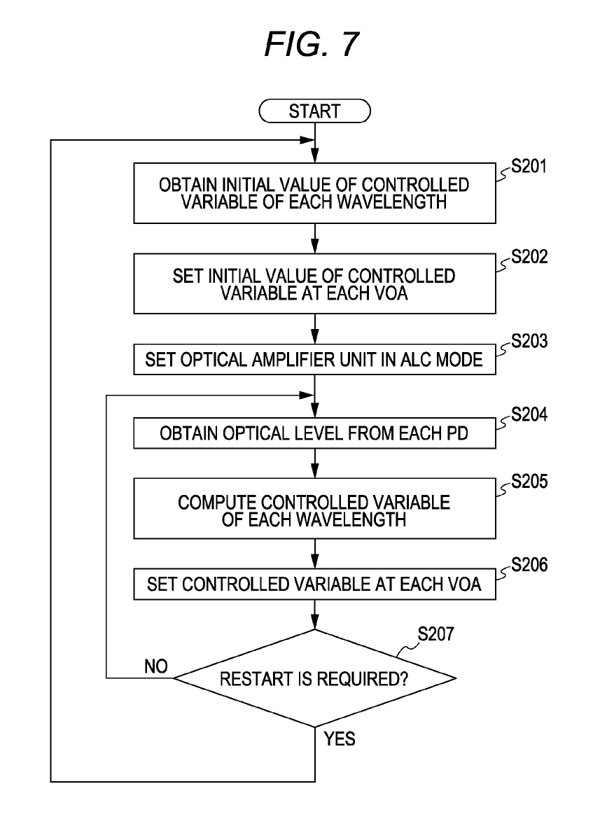

FIG. 7 is a flowchart showing the operation of the conventional optical device control unit. As shown in FIG. 7, when the conventional optical device control unit is started up, the optical device control unit obtains the initial value of the controlled variable of each wavelength (Operation S201). At this point, the obtained initial value is a constant value which is set to be adjusted. The conventional optical device control unit sets the initial value of the controlled variable at each VOA (Operation S202), and the optical amplifier unit is set in the ALC mode (Operation S203).

Then, the optical device control unit obtains the optical level from each PD (Operation S204), the optical device control unit computes the controlled variable of each wavelength from the obtained optical level and the target level (Operation S205), and the optical device control unit sets the computed controlled variable at each VOA (Operation S206). The pieces of the process from Operation S204 to Operation S206 are repeatedly performed, which brings the optical level of each wavelength close to the target level (No in Operation S207).

In the case where the restart is required (Yes in Operation S207), the conventional optical device control unit resumes the operation from Operation S201 to set a constant value previously set as the controlled variable at each VOA.

In Operation S205, in order to prevent the failure generation caused by the rapid variation of the optical level, the controlled variable is computed such that the variation is not increased larger than a predetermined width. Therefore, in the VOA control performed by the conventional optical device control unit, it takes a long time for the light having each wavelength to become the objective level, and sometimes the communication error is generated in the meantime.

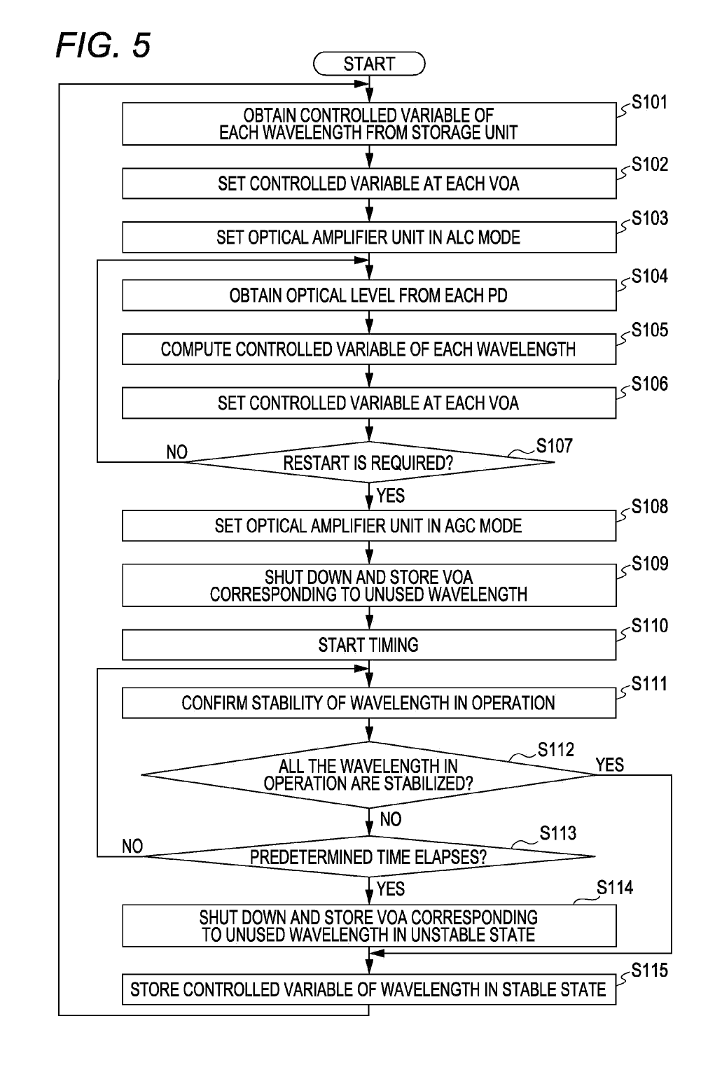

FIG. 5 is a flowchart showing the operation of the optical device control unit 19 of FIG. 4. As shown in FIG. 5, when an optical device control unit 19 is started up, the optical level control unit 191a reads the controlled variable information 194a to obtain the controlled variable of each wavelength which is stored by the controlled variable saving unit 191b before the start-up (Operation S101). The optical level control unit 191a sets the read controlled variables at VOAs 16a to 16n (Operation S102). The optical amplifier control unit 191d sets the reception amplifier modules 20a and 20b and the transmission amplifier modules 30a and 30b in the ALC mode which is of an initial mode (Operation S103).

Then, the optical level control unit 191a obtains the optical levels from PDs 17a to 17n (Operation S104), the optical level control unit 191a computes the controlled variable of each wavelength from the obtained optical level and the target level (Operation S105), and the optical level control unit 191a sets the computed controlled variables at VOAs 16a to 16n (Operation S106). The optical level control unit 191a repeatedly performs the operations in Operations S104 to S106. Therefore, the optical level control unit 191a corrects the controlled variable such that the optical level of each wavelength is maintained at the objective level, and the optical level control unit 191a brings the optical level of the wavelength close to the objective level when the wavelength in which the communication is newly started exists (No in Operation S107).

When the restart is required (Yes in Operation S107), the optical amplifier control unit 191d sets the reception amplifier modules 20a and 20b and the transmission amplifier modules 30a and 30b in the AGC mode in order to stabilize the communication state (Operation S108). The optical level control unit 191a sets VOA corresponding to the unused wavelength at the shut-down state, and the controlled variable saving unit 191b stores the controlled variables of the wavelengths as the controlled variable information 194a (Operation S109).

Then, the stable state determination unit 191c starts the timing with the timer unit 192 (Operation S110), and the stable state determination unit 191c confirms the stability of the wavelengths until determining that all the wavelengths in operation are stabilized (Operation S111). When the stable state determination unit 191 c determines that all the wavelengths in operation are stabilized (Yes in Operation S112), the controlled variable saving unit 191b stores the controlled variables of the wavelengths in the stable state as the controlled variable information 194a (Operation S115). Then, the optical device control unit 19 resumes the operation from Operation Si 01, and the optical device control unit 19 controls VOAs 16a to 16n while the controlled variable saved by the controlled variable saving unit 191b is set at the initial value.

On the other hand, if a predetermined time elapses while the stable state determination unit 191c does not determine that all the wavelengths in operation are stabilized (Yes in Operation S113), the optical level control unit 191a sets VOA corresponding to the wavelength which is not in the stable state at the shut-down state, and the controlled variable saving unit 191b stores the controlled variables of the wavelengths as the controlled variable information 194a (Operation S114). The controlled variable saving unit 191b stores the controlled variable of the wavelength in the stable state as the controlled variable information 194a (Operation S115). Then, the optical device control unit 19 resumes the operation from Operation S101, and the optical device control unit 19 controls VOA 16a to 16n while the controlled variable saved by the controlled variable saving unit 191b is set at the initial value.

Thus, in the embodiment, when the restart is required, the controlled variable saving unit 191b stores the controlled variable which the optical level control unit 191a gives to the VOAs 16a to 16n as the controlled variable information 194a. After the restart, the optical level control unit 191a resumes the control of VOAs 16a to 16n while the controlled variable stored as the controlled variable information 194a is set at the initial value. Therefore, the optical level control unit 191a can set the optical signal at the objective level for a short time after the restart, and the optical level control unit 191a can prevent the unstable communication.

In the embodiment of the invention, the optical add and drop multiplexer is described by way of example. However, the invention can also effectively be applied to other pieces of optical transmission apparatus except for the optical add and drop multiplexer. In the embodiment, the wavelength whose instability is determined by the stable state determination unit 191c after the predetermined elapses is set at the shut-down state. Alternatively, the wavelength is not set at the shut-down state, but the restart may be stopped to inform the network manager of the unstable wavelength through the operation systems 3a and 3b.

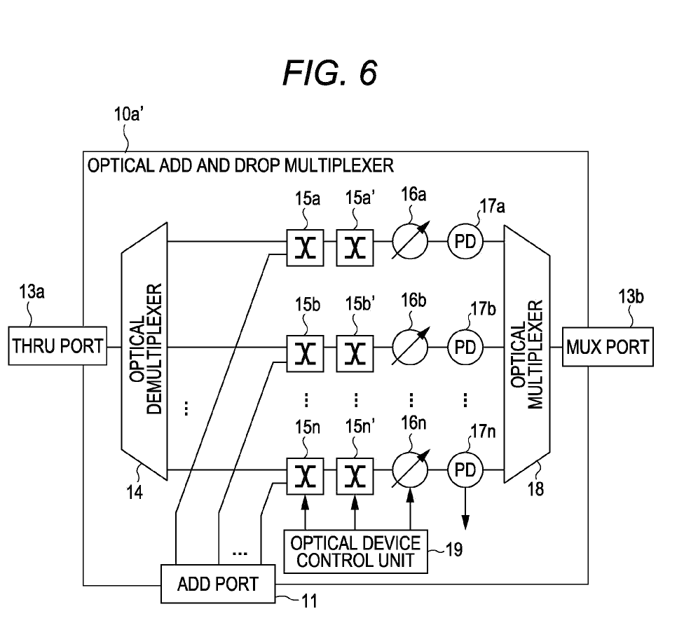

In the embodiment, the optical signal having the particular wavelength is set at the shut-down state by maximizing the attenuation of a VOA. Sometimes, however, the optical signal cannot completely be cut off even if the attenuation of the VOA is maximized. Therefore, in an optical add and drop multiplexing module 10a′ shown in FIG. 6, optical switches 15a′ to 15n′ are provided between the optical switches 15a to 15n and VOAs 16a to 16n, and the optical signal having the particular wavelength may be set at the shut-down state by flips of the optical switches 15a′ to 15n′.

Although the embodiments of the present inventions have been described in detail, it should be understood that the various changes, substitutions, and alterations could be made hereto without depending from the sprit and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical transmission apparatus which repeats an optical signal, the optical transmission apparatus comprising:
an optical level controller for autonomously controlling an optical device such that an optical level of the supplied optical signal becomes an objective level; and
a controlled variable storer for storing a controlled variable in storage if a restart is required, the optical level controller providing the controlled variable to control the optical signal,
wherein the optical level controller starts the control of optical device after the restart while the controlled variable stored in the storage by the controlled variable storer is set at an initial value.

2. The optical transmission apparatus according to claim 1, further comprising a stable state determiner for determining whether or not the optical signal is stabilized,
wherein the controlled variable determiner stores the controlled variable in the storage when the stable state determiner determines that the optical signal is stabilized, the optical level controller providing the controlled variable to control the optical signal.

3. The optical transmission apparatus according to claim 2, wherein the optical level controller sets the optical signal at a shut-down state when the stable state determiner determines that the optical signal is not stabilized even if a predetermined time elapses.

4. The optical transmission apparatus according to claim 1, further comprising an optical amplifier controller for making a transition of a control mode of an optical amplifier unit from an ALC mode in which the optical level is kept constant to an AGC mode in which a gain is kept constant before the restart is performed, the optical amplifier unit amplifying the optical signal.

5. The optical transmission apparatus according to claim 1, further comprising an updater for updating firmware or a programmable device,
wherein the updater causes the controlled variable storer to save the controlled variable when the restart is required to update the firmware or the programmable device.

6. A restart control method for controlling a restart of an optical transmission apparatus, the optical transmission apparatus including autonomously controlling an optical device such that an optical level of a supplied optical signal becomes an objective level, the restart control method comprising:
storing a controlled variable in storage;
providing the controlled variable to control the optical signal; and
starting control of the optical device after the restart while the controlled variable stored in the storage is set at an initial value.

7. The restart control method according to claim 6, further comprising:
determining whether or not the optical signal is stabilized,
storing the controlled variable in the storage if a determination that the optical signal is stabilized is made, and
providing the controlled variable to control the optical signal.

8. The restart control method according to claim 7, further comprising:
setting the optical signal at a shut-down state if a determination that the optical signal is not stabilized is made even if a predetermined time has elapsed.

9. The restart control method according to claim 6, further comprising:
making a transition of a control mode of an optical amplifier unit from an ALC mode in which the optical level is kept constant to an AGC mode in which a gain is kept constant before the restart is performed, the optical amplifier unit amplifying the optical signal.
